(19) United States
(12) Patent Application Publication
(10) Pub. No.: US 2024/0351823 A1
(43) Pub. Date: Oct. 24, 2024

(54) MOBILE DEVICE AND METHOD FOR MONITORING AN ELEVATOR SYSTEM

(71) Applicant: Inventio AG, Hergiswil (CH)

(72) Inventors: Roland Delvento, Büren NW (CH); Andreas Egger, Kriens (CH); Flavio Greissinger, Küssnacht (CH); Reto Hugentobler, Ennetbürgen (CH); Peter Mori, Rothenburg (CH); Martin Rigert, Kriens (CH); Martin Rogger, Rotkreuz (CH); Ruedi Stocker, Eschenbach LU (CH); Oliver Wuthrich, Eich (CH); Andreas Bertram, Luzern (CH)

(21) Appl. No.: 18/685,529

(22) PCT Filed: Aug. 18, 2022
(86) PCT No.: PCT/EP2022/073026

§ 371 Date: Feb. 22, 2024

(30) Foreign Application Priority Data
Aug. 31, 2021 (EP) 21194063.0

(51) Int. Cl. B66B 3/02; B66B 1/34; B66B 5/00

(52) U.S. Cl. CPC B66B 3/02; B66B 1/3461; B66B 5/0087

(57) ABSTRACT

A mobile device and a method for monitoring an elevator system in a multi-level building use a mobile device having a screen for monitoring the elevator system. The elevator system includes an elevator car movable, under the control of an elevator controller of the elevator system, between the floors of the building in an elevator shaft. The mobile device is able to communicate continuously with the elevator system, in particular with the elevator controller or the elevator car, via the position data of the elevator car such that the current position of the elevator car in the elevator shaft with respect to the position of at least one floor of the building is displayed continuously on the screen of the mobile device.

### FIELD

The present invention relates to a mobile device and to a method for monitoring an elevator system in a multi-level building and to an elevator system which can be monitored by such a mobile device or method.

### BACKGROUND

Elevators are used for transporting people by an elevator car within an elevator shaft of a building and between different floors. In order to be able to ensure the safety of passengers or service personnel, the elevator system must be inspected and serviced regularly or periodically. To carry out inspection and maintenance work, an elevator system must be put into an inspection or maintenance operating mode in which the elevator car may travel only via manual control at a walking speed, possibly only between certain positions. In order to put the elevator system into the inspection operating mode or to manually control the elevator car during maintenance work, a service technician must normally first reach the elevator shaft via a shaft door or maintenance hatch, because an inspection control device is generally located in the shaft, specifically arranged on the roof of the elevator car or in the shaft pit of the elevator system.

A door contact switch is typically provided on each shaft door and the car door of an elevator system, which switch is closed as long as the car door and/or the shaft door are closed and remains open as long as one or the two doors are open. Such door contact switches are connected in series with other safety elements of the elevator system, as a result of which a safety chain of the elevator system as a whole is closed only when all door contact switches are closed. The safety chain is interrupted when a so-called “contact unlocking shaft door switch” (KNET switch) is unlocked outside of an elevator shaft, wherein the KNET switch is typically actuated by a triangular wrench. The KNET switch is used for maintenance/inspection work on an elevator system in order to be able to manually open a shaft door of the elevator system on a floor regardless of the current position of the elevator car. If the KNET switch is activated, the elevator car is displaced beyond a permissible travel path, for example in the direction of an elevator shaft ceiling or in the direction of an elevator shaft floor. In contrast to a door contact switch mentioned above, by unlocking the KNET switch a shaft door can be manually opened regardless of where the elevator car is located. If the shaft door is opened, the elevator car is stopped immediately because of the broken safety chain.

Since the shaft doors remain closed during operation of the elevator system, the current position of the elevator car cannot be seen from the outside. In order to hold the elevator car in a desired position or on a desired floor to make it easier to access the roof of the elevator car or enter the elevator car, a technician must put great effort into opening and closing the shaft door on the floor repeatedly using the KNET switch so that the elevator car can move step by step to reach the desired position as the defined stop position. It is also known that when the KNET switch is activated, the elevator car of some elevator systems can automatically move to a predefined floor-normally the top floor-and stop there. In this case, the technician can enter the elevator shaft only at this floor. If the maintenance work is to be carried out on a different floor, e. g., on the first floor, the technician must first switch the elevator system to an inspection operating mode and move slowly down from that floor with the elevator car at a walking speed. Another disadvantage of using a KNET switch is that there is often no elevator car waiting behind an open shaft door. Such a dangerous case should always be avoided. Even if a technician is already in the elevator shaft, it is still difficult for him to see exactly where or on what floor the elevator car has stopped. However, it should be possible to continuously monitor the current position of the elevator car during maintenance of the elevator system.

Among other things, there may be a need to, on the one hand, avoid a dangerous case mentioned above and to, on the other hand, be able to easily monitor the current position of an elevator car of an elevator system at any time both inside and outside of an elevator shaft of the elevator system, in particular during installation and maintenance work.

### SUMMARY

Such a need can be met by the subject matter of the advantageous embodiments that are defined in the following description.

According to the invention, a mobile control device with a screen for monitoring an elevator system is provided, wherein the elevator system is located in a multi-level building, wherein an elevator car is movable, under the control of an elevator controller of the elevator system, between the floors of the building in an elevator shaft of the elevator system. The mobile device is able to communicate continuously with the elevator system, in particular with an elevator controller or the elevator car, via the position data of the elevator car such that the current position of the elevator car in the elevator shaft with respect to the position of the at least one floor of the building can be displayed continuously on the screen of the mobile device. The mobile device can be, for example, a mobile telephone or a smartphone, a laptop, a tablet computer, or any portable communication device. That is why a technician can get a better overview of to what floor the current position of the elevator car is closer, and can decide faster from what floor he can easily enter the elevator shaft or elevator car in order to complete a specific task, without either having to laboriously activate a KNET switch on a floor or being able to enter or exit only on a predefined, specific floor.

Hereinabove and below, “current position” means that the indicated position of the elevator car on the mobile device is adapted precisely, i.e., continuously and non-discretely for the viewer and in small time intervals, e.g., in a time interval of less than a millisecond, to the position of the actual position of the car. In other words, the position indicated corresponds to the actual position of the car at any time.

According to an advantageous embodiment of the invention, the mobile device is designed such that the current position of the elevator car in the elevator shaft with respect to the respective positions of all floors of the building can be displayed on the screen of the mobile device. Advantageously, the elevator car and the respective floors are displayed on the screen of the mobile device in a manner proportional to their size.

According to an advantageous embodiment of the invention, a highest and/or lowest stop position in the elevator shaft reachable by the elevator car can be displayed on the screen. The highest or the lowest stop position of the elevator car does not mean the landing position on the highest or lowest floor. Normally, the highest stop position is higher than the highest landing position, and the lowest stop position is lower than the lowest landing position. Moreover, a start position and/or a target position of a booked travel of the elevator car can also be displayed on the screen.

According to a further advantageous embodiment of the invention, a maintenance stop position of the elevator car can be displayed on the screen, wherein the maintenance stop position for a specific maintenance task is already predefined, and wherein the maintenance task can be determined either by the mobile device or by a remote center for the elevator system.

According to a further advantageous embodiment of the invention, the mobile device can be connected to a local and/or public network. As a result, communication can be established between the mobile device and a remote control center or a server or cloud server. It is then possible to download, by means of the mobile device, documents required at the location of the elevator system to fulfill a maintenance/inspection task, for example from a server, or to upload them to a server.

According to a further advantageous embodiment of the invention, the mobile device can communicate with the elevator controller, as a result of which the mobile device can switch the elevator system between its normal mode and its inspection mode, wherein, in the inspection mode, the elevator car can be controlled manually by the mobile device for moving, namely upwards and downwards. The mobile device can thus comprise a switching means such as, for example, an electromechanical means and/or a software function (e.g., application software: app) for switching the elevator system. Compared to an automatic control of the elevator car, which for example is carried out by the elevator controller during normal operation of the elevator system, manual control means that the elevator system responds only to a current handling by an individual by means of a switch (e.g., a key, a button or an app of the mobile device), which directly causes the elevator car to move; after handling, the response of the elevator system or the movement of the elevator car ends as well. Typically, an elevator car travels at a higher travel speed or greater acceleration under automatic control, and travels only at a low travel speed or smaller acceleration under manual control. Thus, in the inspection mode of the elevator system, a technician can move the elevator car comfortably and precisely by operating the mobile device in order to be able to stop the elevator car flexibly and as desired.

Moreover, according to the invention a method for monitoring an elevator system in a multi-level building is provided, wherein an elevator car is moved, under the control of an elevator controller of the elevator system, between the floors of the building in an elevator shaft of the elevator system. A mobile device as described above communicates continuously with the elevator system, in particular with the elevator controller or the elevator car, via the position data of the elevator car such that the current position of the elevator car in the elevator shaft with respect to the position of the at least one floor of the building is displayed continuously on the screen of the mobile device.

Furthermore, according to the invention, an elevator system in a multi-level building is provided, wherein an elevator car is movable, under the control of an elevator controller of the elevator system, between the floors of the building in an elevator shaft of the elevator system, wherein the elevator system can be monitored by means of a mobile device mentioned and described above or is monitored by a method described above. In particular, the current position of the elevator car in the elevator shaft with respect to the respective positions of all floors of the building can be continuously displayed on the screen of the mobile device. The current position of the elevator car can be a stationary stop position or a current position which moves continuously during a travel of the elevator car. Thus, a technician can get at least an overview of how the elevator car moves with respect to the floors of the building and on which floor it is held.

It should be noted that some of the possible features and advantages of the invention are described herein with reference to different embodiments. A person skilled in the art will recognize that the features can be suitably combined, adapted, or exchanged in order to arrive at further embodiments of the invention.

Embodiments of the invention will be described below with reference to the accompanying drawings, wherein neither the drawings nor the description are intended to be interpreted as limiting the invention.

### DESCRIPTION OF THE DRAWINGS

FIG. 1 is a schematic depiction of an elevator system with a mobile device according to the invention; and

FIG. 2 is a plan view of a mobile device according to the invention.

### DETAILED DESCRIPTION

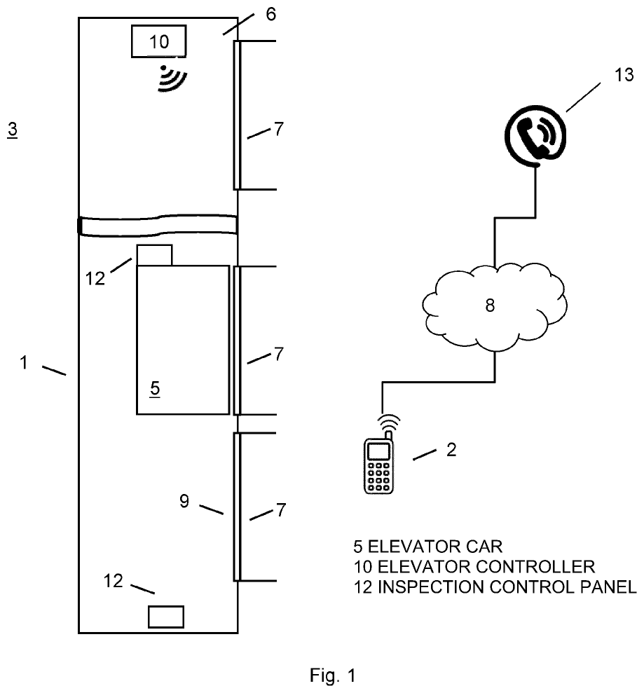

FIG. 1 shows a depiction an elevator system 1 installed in a building 3 with multiple floors or levels 7. The elevator system 1 comprises an elevator car 5 and an elevator controller 10, wherein, during normal operation of the elevator system 1, the elevator car 5 can automatically move, under the control of an elevator controller 10, between the floors 7 in an elevator shaft 6 of the elevator system 1. A shaft door 9 is provided on each floor 7 and a car door (not shown) is provided on the elevator car 5. The shaft door 9 can be opened or closed alone or together with the car door. When one of the shaft doors 9 or the car door is opened, the elevator car 5 is immediately blocked for moving.

According to the invention, a mobile device 2 for monitoring the elevator system 1 is provided. The mobile device 2 is, for example, a smartphone or any portable communication device. Wireless communication with the elevator controller 10 or the elevator car 5 can be established by means of the mobile device 2 so that the mobile device 2 can monitor and control the movement or the position of the elevator car 5. After successfully establishing communication, the mobile device 2 can control the elevator system 1 accordingly. This means that a technician, i.e., the user (not shown) of the mobile device 2, can switch the elevator system 1 both outside and inside the elevator shaft 6 to inspection mode or normal operation using the mobile device 2. It is then no longer necessary to arrange an inspection control panel 12 in the elevator shaft 6, i.e., in the shaft pit and on the roof of the elevator car 5. The functions of the inspection control panel 12 can be taken over by the mobile device 2 at least in part. Thus, it is no longer necessary for the technician to first laboriously enter the elevator shaft 6 and switch the elevator system 1 to inspection mode before performing maintenance work.

After the elevator system 1 has been set to inspection mode, the technician can manually control the elevator car 5, by means of the mobile device 2, to move at a low driving speed and can move it to any position in the elevator shaft 6 or hold it there. The mobile device 2 can also be connected to a local and/or public network 8, as a result of which the mobile device 2 can download information from the network 8 or upload it to the network 8, such as, for example, retrieve auxiliary information for maintenance work or send a report. Furthermore, the mobile device 2 can be connected to a remote center 13 via the network 8, whereby a remote maintenance or diagnosis for the elevator system 1 can be made possible. If the elevator system 1 is switched back to normal operation, the mobile device 2 is disconnected from the elevator system 1. The elevator system 1 is then automatically controlled by the elevator controller 10.

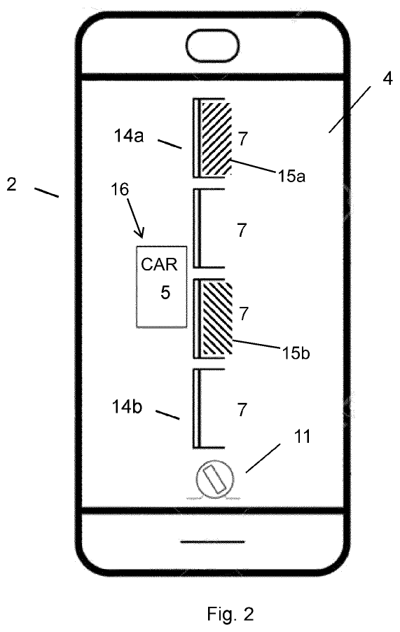

FIG. 2 shows a mobile device 2 according to the invention with a screen 4. To monitor an elevator system 1, which is shown, for example, in FIG. 1, the mobile device 2 can communicate with the elevator system 1, as a result of which the current position of the elevator car 5 in the elevator shaft 6 with respect to the position of a floor 7 or the respective positions of several or all floors 7 of the building 3 can be graphically displayed continuously on the screen 4. Advantageously, the elevator car 5 and the respective floors are displayed in a manner proportional to their size. A highest stop position 14a and/or a lowest stop position 14b in the elevator shaft 6 reachable by the elevator car 5 can also be displayed on the screen 4. If a target floor is given for a travel of the elevator car 5, a start position and a target position of the booked travel of the elevator car 5 can be displayed on the screen 4, such as, for example, the start position 15a or the target position 15b is indicated in each case by a diagonally hatched region slanted downwardly to the left or right respectively. The representation on the screen 4 can be zoomed in or out so that a different or better perspective of the position of the elevator car 5 with respect to the respective floors 7 is enabled for the user of the mobile device 2.

A maintenance stop position 16 of the elevator car 5 can be displayed on the screen 4, wherein the maintenance stop position 16 for a specific maintenance task is already predefined, and wherein the maintenance task can be determined either by the mobile device 2 or by a remote center 13 for the elevator system 1.

The mobile device 2 moreover has at least one switch 11, which is provided for switching the elevator system 1 between normal operation and the inspection mode or for controlling the elevator car 5 in the inspection mode. The switch 11 can be configured either as an electromechanical switch (e. g., a key or button) or an app or a graphical menu entry on a user interface for the mobile device 2.

In summary, embodiments of the mobile device 2 presented herein or a method for monitoring or controlling an elevator system 1 in an inspection mode allow, wherein greater mobility and better safety is achieved for a technique inside or outside the elevator shaft 6 of the elevator system 1.

It should be noted that possible features and advantages of embodiments of the invention are described herein partly with reference to a method according to the invention and partly with reference to a device according to the invention. A person skilled in the art will recognize that the individual features can be combined, modified, or exchanged in a suitable manner and that features described in particular for the method can be transferred analogously to the device and vice versa in order to arrive at further embodiments of the invention.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A mobile device for monitoring an elevator system in a multi-level building, the elevator system including an elevator car movable, under control of an elevator controller of the elevator system, between floors of the building in an elevator shaft of the elevator system, the mobile device comprising:
a screen adapted to display graphical information representing the elevator system; and
wherein the mobile device communicates continuously with the elevator system to receive position data of the elevator car, the mobile device responding to the position data to continuously display on the screen a current position of the elevator car in the elevator shaft with respect to a position of at least one of the floors of the building.

17. The mobile device according to claim 16 wherein the current position of the elevator car in the elevator shaft with respect to respective positions of each of the floors of the building is continuously displayed on the screen.

18. The mobile device according to claim 16 wherein at least one of a highest stop position and a lowest stop position in the elevator shaft reachable by the elevator car is displayed on the screen.

19. The mobile device according to claim 16 wherein at least one of a start position and a target position of a booked travel of the elevator car is displayed on the screen.

20. The mobile device according to claim 16 wherein a maintenance stop position of the elevator car is displayed on the screen, the maintenance stop position being predefined for a specific maintenance task, and the specific maintenance task is determined either by the mobile device or by a remote center for the elevator system.

21. The mobile device according to claim 16 adapted to connect with at least one of a local network and a public network.

22. The mobile device according to claim 16 including communicating with the elevator controller to switch the elevator system between a normal operation mode and an inspection mode, and wherein when in the inspection mode of the elevator system movement of the elevator car is controlled manually by the mobile device.

23. An elevator system in a multi-level building, the elevator system comprising:
an elevator car movable in an elevator shaft;
an elevator controller controlling movement of the elevator car between floors of the building in the elevator shaft; and
the mobile device according to claim 16 adapted to monitor the elevator system and display the current position of the elevator car in the elevator shaft.

24. A method for monitoring an elevator system in a multi-level building, the elevator system having an elevator car that is moved, under control of an elevator controller of the elevator system, between floors of the building in an elevator shaft of the elevator system, the method comprising the steps of:
operating a mobile device to communicate continuously with the elevator system to obtain position data of the elevator car in the elevator shaft; and
utilizing the position data to continuously display a current position of the elevator car in the elevator shaft with respect to a position of at least one of the floors of the building on a screen of the mobile device.

25. The method according to claim 24 including utilizing the position data to continuously display the current position of the elevator car in the elevator shaft with respect to respective positions of all the floors of the building on the screen of the mobile device.

26. The method according to claim 24 including displaying on the screen at least one of a highest stop position and a lowest stop position in the elevator shaft reachable by the elevator car.

27. The method according to claim 24 including displaying on the screen at least one of a start position and a target position of a booked travel of the elevator car.

28. The method according to claim 27 including displaying on the screen the start position by a diagonally hatched region and the target position by a diagonally hatched region.

29. The method according to claim 24 including displaying on the screen a maintenance stop position of the elevator car, wherein the maintenance stop position is predefined for a specific maintenance task, and wherein the specific maintenance task is determined either by the mobile device or by a remote center for the elevator system.

30. The method according to claim 24 wherein the mobile device is connected to at least one of a local network and a public network.

31. The method according to claim 24 wherein the mobile device communicates with the elevator controller to switch the elevator system between a normal operation mode and an inspection mode, and wherein when in the inspection mode of the elevator system movement of the elevator car is controlled manually by the mobile device.

32. An elevator system in a multi-level building, the elevator system comprising:
an elevator car movable in an elevator shaft;
an elevator controller controlling movement of the elevator car between floors of the building in the elevator shaft; and
a mobile device monitoring the elevator system and performing the method according to claim 24 to display the current position of the elevator car in the elevator shaft on a screen of the mobile device.
